(19) United States
(12) Patent Application Publication
(10) Pub. No.: US 2026/0178258 A1
(43) Pub. Date: Jun. 25, 2026

(54) DYNAMIC VENUE PLAYLISTS BASED ON CUSTOMER PREFERENCES

(71) Applicant: Adeia Guides Inc., San Jose, CA (US)

(72) Inventors: Serhad Doken, Bryn Mawr, PA (US); Charles Dasher, Lawrenceville, GA (US); Tao Chen, Palo Alto, CA (US)

(21) Appl. No.: 18/989,314

(22) Filed: Dec. 20, 2024

(51) Int. Cl. G06F 3/16; G06Q 30/0202; G06Q 30/0204; H04W 4/021; H04W 4/80

(52) U.S. Cl. CPC G06F 3/165; G06F 3/162; G06Q 30/0202; G06Q 30/0205; H04W 4/021; H04W 4/80

(57) ABSTRACT

Systems and methods for dynamic venue playlist generation are disclosed, which uses short-range communication protocols to detect customer devices within an area and generate personalized playlists, with content, such as music, based on the user preferences and detected device movement. The system continuously monitors device locations, updates playlists accordingly, and removes songs from previous areas as customers move through areas of the venue. Some embodiments may include updating playlist priorities and positions based on multiple customer profiles, providing an enhanced audio experience tailored to individual tastes in, e.g., different areas of a venue. Dynamic playlists may be generated in various venues, such as stores, malls, restaurants, bars, lounges, and other establishments where music or other content plays a significant role in the overall experience.

### BACKGROUND

The present disclosure is directed towards systems and methods for creating a dynamic venue playlist. In particular, systems and methods are provided herein for adding one or more content items to a venue playlist based on profiles of customers currently present in the venue.

### SUMMARY

In retail environments like stores and malls, venues can typically provide content tailored to their target audience. For example, a clothing store catering to teens might play popular music to create an appealing atmosphere for young adults. Other types of content, such as audio, video, podcasts, blogs, ebooks, audiobooks, multimedia, and more may be provided based on assumptions about currently present customers. However, providing dynamic personalized content based on the preferences of customers actually currently visiting the venue is challenging.

Traditional location-based detection methods like GPS signals often fall short in indoor environments. Such approaches can struggle to accurately pinpoint a customer's location within a large mall or store, resulting from weak or unreliable signal strength indoors. This makes it difficult for venues, applications, and other services to provide personalized playlists based on the customer's physical location.

As disclosed herein, systems and methods generate personalized playlists for indoor venues like stores and malls based on detecting the presence of a customer using short-range signals. Some embodiments involve, e.g., detecting a first customer device in a first area using short-range communication. Once detected, a song associated with a customer profile (e.g., a streaming profile, preferences, and/or recently played list) associated with that device is added to a dynamic grand venue playlist. As more devices are detected, such as a second customer device, their corresponding songs are also added to the playlist. If one of the devices, like the first customer device, is no longer in the first area, its associated song is removed from the playlist before being played. If the first customer device is detected to move to a second area, the song may be removed from the first area playlist and added to a second area playlist. If another device, like the second customer device (e.g., a second customer's phone), remains within the area, its associated song continues to be played from the playlist. Some embodiments may request location data or otherwise check to see if the first customer device is still present in the first area as the selected content approaches in the area playlist.

In some embodiments, the system collects information from customers who are physically present at the venue, as well as their personal preferences. This can be achieved through various means, such as detecting and tracking devices using Bluetooth Low Energy technology or other short-range wireless communication methods. Profiles may be accessed through the customer device and/or via a remote profile database. Some embodiments may select content from a content database based on matching, e.g., a title, an artist, a group, a band, a producer, a genre, an album, a tempo, a release timeframe, last played data, a playlist, popularity level, sales data, or other customer profile data and/or preferences. The system can also tap into customers' social media profiles to gather information about their content preferences, interests, and demographics. Additionally, customers can provide explicit feedback on their experience at the venue, such as rating the music or providing suggestions for future playlists. The collected data is then aggregated and analyzed to create a comprehensive picture of the target audience's preferences.

Some embodiments may use a dynamic algorithm to generate a playlist based on coefficients that can be adjusted by the venue owner to suit their target audience. In some examples, these coefficients can be tailored to achieve specific goals, such as attracting first-time visitors by prioritizing popular or trending content. In some embodiments, the system can also focus on playing music that is familiar and enjoyable for regular customers, potentially incorporating their personal playlists or preferences. Furthermore, in some embodiments, the algorithm can generate playlists that complement the in-venue atmosphere and enhance the overall shopping experience by analyzing customer behavior and feedback. In some embodiments, the venue owner may set a pre-determined genre and only select content associated with customer profiles which match that genre.

By combining crowd-sourced data with dynamic playlist generation, the music streaming service's system provides a unique and personalized experience for each customer, based on their individual preferences and behavior within the venue. The dynamic nature of this algorithm ensures that the playlist adapts to changing customer demographics and music trends. This flexibility allows the system to continually optimize its recommendations and improve the accuracy of content selection for customers currently present.

Additionally, the system may display information regarding the dynamic venue playlist on a map for users to view. Users may be able to view the genre of or current song playing in a playlist at various locations. This would enable users to view the choices of music at various venues and select a venue based on their personal tastes. Some embodiments may provide an application programming interface (API) for accessing venue music data and displaying content indication(s) on a map. In some embodiments, the dynamic venue playlist for a selected venue may offer and/or add content based on, e.g., the user's preferences and/or selected content to further entice the user to visit. In some embodiments, the dynamic venue playlist for a selected venue may prepare to play content based on the user's selection of the venue and/or location information, e.g., based on playing content upon the user's arrival.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment in which venue playlists are generated for different zones in the venue and updated based on a customer moving between the zones, in accordance with some embodiments of the disclosure;

FIG. 2 shows an example environment in which a venue playlist is generated from the streaming profiles of two customers, in accordance with some embodiments of the disclosure;

FIG. 3 shows example architecture for generating playlists for different zones in a venue, in accordance with some embodiments of the disclosure;

FIG. 4 shows an example sequence diagram for generating playlists from the streaming profiles of multiple customers, in accordance with some embodiments of the disclosure;

FIG. 5 shows an example map user interface that allows for searching venues by genre of playlists, in accordance with some embodiments of the disclosure;

FIGS. 6-7 depict exemplary devices, systems, servers, and/or related hardware for streaming content in a low latency system, in accordance with some embodiments of the present disclosure;

FIG. 8 is a flowchart depicting illustrative steps involved in generating a venue playlist, in accordance with some embodiments of the disclosure;

FIG. 9 is a flowchart depicting illustrative steps involved in generating a venue playlist based on detecting two customer devices, in accordance with some embodiments of the disclosure; and

FIG. 10 is a flowchart depicting illustrative steps involved in generating a venue playlist based on priority associated with two detected customer devices, in accordance with some embodiments of the disclosure.

### DETAILED DESCRIPTION

Systems and methods are described herein for creating a playlist at a venue using customer data. Generally, a playlist may refer to a list of one or more digital files of one or more file types to be played in a specified order. Some embodiments may use one or more of songs (e.g., MP3, AAC, AIFF, FLAC, WAV files, etc.), music videos (e.g., MP4, AVI, MOV, WMV, MKV, FLV, etc.), movie clips, scenes, segments, user-created content, memes, images, GIFs, audiobooks, podcasts, television programs/channels, radio programs/channels, streaming platforms, and other content. Some embodiments may present audio-visual content via speakers, headphones, televisions, displays, projectors, headsets, AR/VR/XR glasses, and more. Music is considered a simple but effective way for business owners to create a specific ambiance in their store. There is nuanced psychological research into tempo, mode, genre, and recognizability of music in a store that may influence customer choices. For example, slow business music encourages customers to linger and look through the store more, and songs in a major key sound happy to most shoppers.

Businesses have a need to create playlists that are curated for customers in the store Additionally, different playlists may play in different zones of the store and need to be updated as a customer moves from one zone to another. For example, a customer may walk from one store in a mall to another. In another example, a customer may walk from one department to another within a department store where different departments are playing different playlists.

Some approaches require the store/retail employees to curate a specific list for customers that are in the store. Employees can be expected to manually perform as a DJ. Centralized solutions can have issues of pigeonholing all customers into a single mold. This problem is compounded when a particular brand has many stores, for instance a global brand like Zara. Taste of music for one Zara store's customers may be vastly different from tastes for another Zara store location visitors. Some approaches may require customers to manually request and/or add songs to a playlist, e.g., using credits and/or payment. This does not result in an inclusive experience and can be manipulated by high spending and/or remote requests.

Using content such as music to help create an atmosphere or environment to drive sales is critical for certain businesses such as gyms, salons, spas, grocery stores, medical offices, bars/pubs, pools, churches, schools, hotels, restaurants, cafes, coffee shops, offices, stadiums, sports fields, transportation centers, airports, conference centers, residences, rooms, etc. Other venues may use such music to set the mood, atmosphere, and/or culture for their location. Furthermore, consumers may also seek out a certain music type or audio mood when they are a patron for businesses or visiting such venues. Moreover, given the prevalence of consumer-based services, people expect stores/venues to have music and if they do not, it is not surprising that some consumers walk around with their headphones on in such places.

In addition to the difficulty of selecting the best music for customers/visitors, there is also difficulty of venues describing their location to services and/or platforms with exact granularity just with GPS-based technology. For instance, a mall may have a known GPS location; however, there may be, e.g., 20-80 different stores in a mall, and it is difficult to pinpoint the precise location of a store in that mall- and identify which customers are in which store in the mall—with just GPS alone.

This invention discloses a different method of creating location-specific, customized and crowdsourced playlists. Customers visiting a store who have a music streaming app on their mobile device will be the primary beneficiaries of the invention.

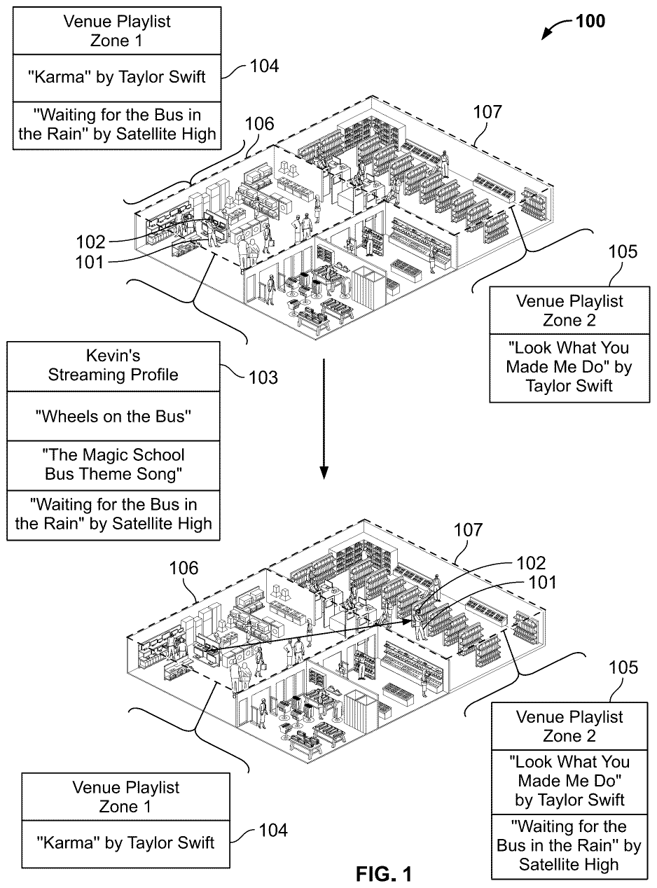

FIG. 1 shows an example environment in which venue playlists are generated for different zones in the venue and updated based on a customer moving between the zones, in accordance with some embodiments of the disclosure.

Venue 100 is made up of various zones including zone 106 and zone 107. In some embodiments, these zones may be different departments of a department store, such as women's apparel, children's toys, makeup, men's shoes, or any other suitable department. In some embodiments, these zones may be different stores within a mall. Each of zone 106 and zone 107 has a separate playlist for the zone which is tailored to the tastes of the customers present in the zone. Zone 106 has playlist 104 while zone 107 has playlist 105.

A device associated with customer 101, Kevin, is detected to be present in zone 106 using short range communication. Customer streaming profile 103 contains various songs including “Wheels on the Bus,” “The Magic School Bus Theme Song,” and “Waiting for the Bus in the Rain” by Satellite High. In some embodiments, the customer streaming profile may comprise songs found on playlists saved by the customer, songs recently played by the customer, or songs that have been marked as a “favorite” by the customer. Upon detecting customer 101 in zone 106, songs from streaming profile 103 may be added to playlist 104. For example, the song “Waiting for the Bus in the Rain” by Satellite High from customer streaming profile 103 has been added to zone 1 playlist 104. Some embodiments may select content based on venue data acquired from one or more sources. For instance, some embodiments may select music from the year 1984 based on identifying that the establishment was opened in that year from map data, comment data, photographic data, videos, etc.

In one embodiment, streaming music service subscribers may receive notifications on their device that, if their favorite song from their playlist will be played at a particular time (within the next 15 minutes or Saturday at 1 p.m., etc.) or is currently being played at a venue. Such notifications may be filtered based on device location and how close it is to the venue location

In some embodiments, customer 101 may be wearing headphones 102 when entering the store. In these embodiments, the system may offer to play playlist 104 in headphones 102.

In some embodiments, if the user device is also detected to have a digital loyalty card for the currently visited venue, a cloud streaming service may inject “personalized announcements” for this user in midst of the venue playlist playback. These announcements may include simple advertisements and/or special deals just for this user tailored to the user's venue loyalty profile. In addition, inserted announcements may include messages related to the ranging of the user with respect to specific zones that the venue owner has prioritized. For instance, if zone 106 is an important zone for the venue owner, the user may receive personalized messages on the device headset about the recently arrived merchandise in that section as their device gets closer to the range of that zone. If the user happens to not have a venue loyalty card or one is not detected in the digital wallet, the personalized announcement may include a pitch about the benefits of the loyalty card. In one embodiment, users, while at one venue, who do not like that venue's playlist may choose to select another venue's playlist, if they are wearing a headset.

However, customer 101 is detected to have moved from zone 106 to zone 107, using short range communication, before the song “Waiting for the Bus in the Rain” by Satellite High has been played. Therefore, the system will transfer the song Waiting for the Bus in the Rain” by Satellite High from zone 1 playlist 104 to zone 2 playlist 105.

In some embodiments, customer 101 may be wearing headphones 102 when moving from zone 106 to zone 107. In these embodiments, the system may fade out playing playlist 106 while customer 101 exits zone 106 and fade in playing playlist 105 when customer 101 enters zone 107.

In some embodiments, one or more screens or displays that are present at the venue may play the specific song that is currently active on the playlist while the display is rendering venue specific content (such as a schedule, specials, discounts, etc.). In order to achieve this, cloud streaming music service input will be piped to the venue display's audio output. In certain implementations, what is being displayed on the screens will be matched to the song that is being received from the cloud streaming service and that will be achieved by doing a similarity comparison between the song metadata and video content metadata collected by analysis. In some embodiments, while a screen is rendering the audio received from the cloud streaming service, if a digital wallet invocation is also detected, the venue display may render a splash screen congratulating the user with a message such as “Yet another Spotify user completes a purchase at Macy's.” The message displayed on the screen may also include advertisements from the cloud streaming service as well.

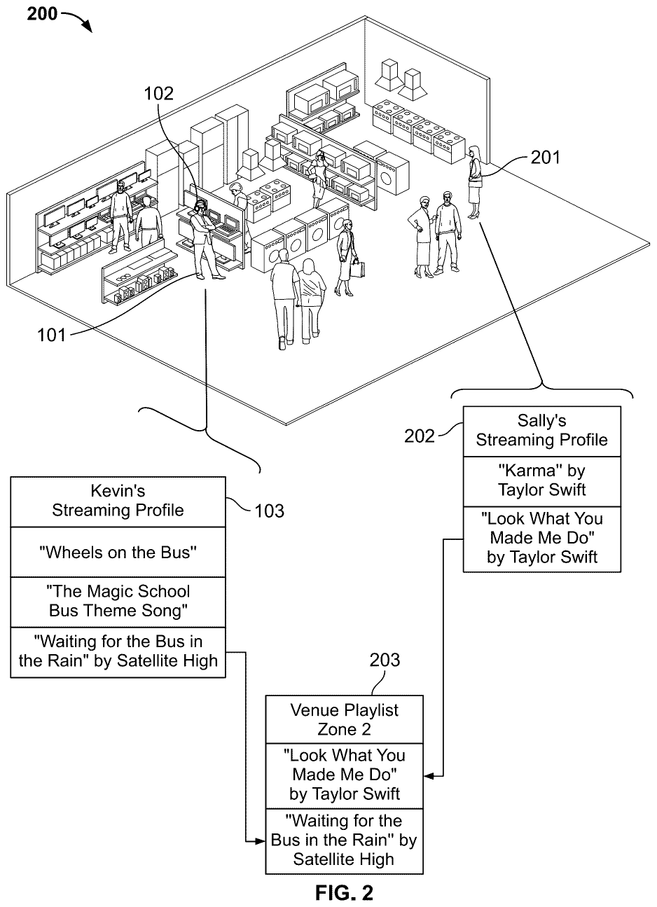

FIG. 2 shows an example environment in which a venue playlist is generated from the streaming profiles of two customers, in accordance with some embodiments of the disclosure.

Devices associated with customer 101, Kevin, and customer 201, Sally, are both detected by short range communication in venue 200. Customer 101 is associated with streaming profile 103 with songs including “Wheels on the Bus,” “The Magic School Bus Theme Song,” and “Waiting for the Bus in the Rain” by Satellite High. Customer 201 is associated with streaming profile 202 with songs including “Karma” by Taylor Swift and “Look What You Made Me Do” by Taylor Swift.

Venue 200 has playlist 203 which is generated by accessing the streaming profiles of customers present. Streaming profile 103 and streaming profile 202 are both accessed and the songs “Waiting for the Bus in the Rain” by Satellite High and “Look What You Made Me Do” by Taylor Swift are selected from each, respectively, to be added to venue playlist 203.

In some embodiments, the songs selected from each streaming profile may be selected based on the preferences of the associated customers, a pre-set genre for the venue, currently trending music, and/or any other suitable selection criteria.

In some embodiments, if the cloud streaming app is seeing a lot of health-related activity detected by a device at a particular venue, it may override the crowdsourced playlist with more songs tailored to the activity. For example, if the device detects at a smart watch that a user is lifting weights at a gym (e.g., based on accelerometers and/or inertial movement sensors), the playlist may update to one that is more upbeat to match the current activity.

In some embodiments, the order of songs in venue playlist 203 may be selected based on when the customer associated with the song entered the zone. In some embodiments, the order of songs in venue playlist 203 may be selected based on detecting that customer 201 is associated with a loyalty account with a higher priority than a loyalty account associated with customer 102. In some embodiments, the order of songs in venue playlist 203 may be selected based on detecting that customer 201 is associated with a larger spending capacity (e.g., a better credit score, higher spending limit, higher estimated net worth and/or income, higher average income based on home address, etc.) than customer 102.

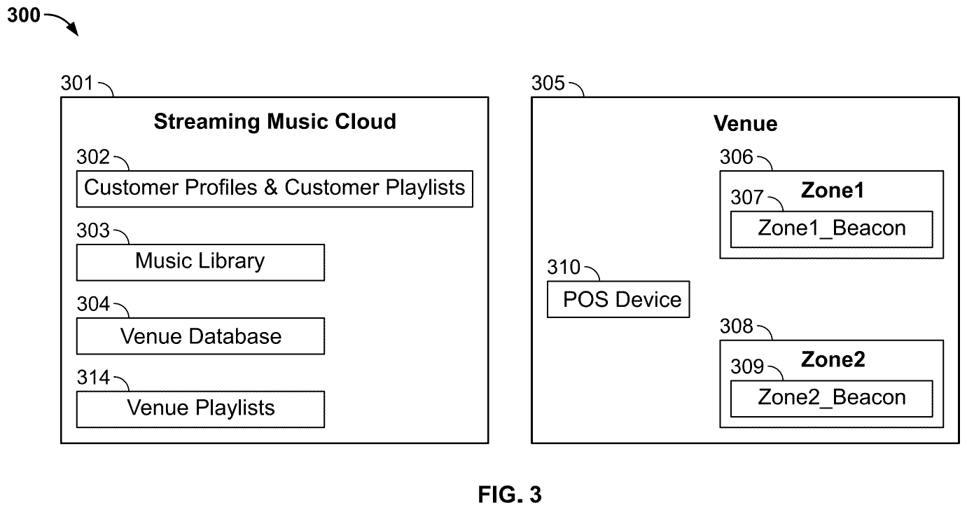

FIG. 3 shows an example architecture for generating playlists for different zones in a venue, in accordance with some embodiments of the disclosure.

Streaming music cloud service 301 contains the information associated with a customer in a store. The customer may have an app for the streaming service on their device. Streaming music cloud service 301 contains customer profiles and customer playlists 302, which venue 305 may access to build venue playlists 314. Streaming music cloud service 301 also contains music library 303 which contains all music available for generating a playlist. Venue database 304 contains historical data for the venue including previously played songs, playlists, and information such as a preset genre for the venue.

Venue 305 contains zone 306 with beacon 307 and zone 308 with beacon 309. POS device 310 can detect when a customer makes a purchase to provide customized in ear announcements and offerings. Beacons 307 and 309 use short range communication, such as Bluetooth® (“BT”) and/or Bluetooth® Low Energy (“BLE” or “Bluetooth LE”), to detect when customers walk from one zone to another.

Most mobile device apps have a privacy setting of whether they can use the location of the device always, never or only while the app is being used. However, the methods disclosed here do not require the tracking of the user's location. Instead, the system relies on cloud-based music streaming service 301 and short-range communication tech at venues such as Wi-Fi or BT. For the latter, beacons 307 and 309 broadcast the availability of the radios and the networks. Some embodiments may also take advantage of a venue using one or more SSIDs (service set identifiers) to specify the Wi-Fi networks that are present in the venue or several access points (APs) that may be distributed throughout.

Customers' music streaming app connected to streaming music cloud 301 will register for a subscription of Wi-Fi or BT firmware drivers to notify it for the presence of the Wi-Fi radio or BT beacon. Identification of such beacon will be relayed to the streaming app. In some embodiments, a streaming app will check with its cloud backend system as top whether this beacon specifies, e.g., a business that has a subscription service with the service/platform. At this point, there is no need to connect to the Wi-Fi or BT network for the invention to function. In order not to get fooled by fake radio beacons imitating a genuine beacon, the certificate for the beacon may also be broadcasted. This enables the app to receive that from the firmware later and have the cloud backend to verify that the beacon does not belong to an impostor but to a subscribing customer, thanks to the certificate.

Some embodiments may also contemplate that the broadcasted radio beacon will transmit a unique identifier that is for that specific venue. This identifier can be part of the information element (“IE”). For instance, the Zara store in New York City's Time Square will have a different ID than the Zara store at the King of Prussia Mall. Rather than using the IE frame within the radio beacon broadcast, another way to signal to the user devices the specific venue location would be to use the aforementioned network certificate. This way, not only can systems know the beacon broadcast is real but the certificate can also carry info about the specific venue ID. Some embodiments can use discovery or authentication/pairing mode of Bluetooth so that this information can be transmitted without establishing a connection. For further security, as well as identification of the venue, Secure UUID may be used during beacon advertising by safeguarding the beacon's RealID. Some embodiments may encrypt the ID with the venueIDs information, which can be decrypted at the cloud back end of the streaming service. Some embodiments may utilize the detection of Wi-Fi and/or the certificate authentication process with, e.g., measuring the Received Signal Strength Indicator (RSSI) of the beacon.

Similarly, in some embodiments, the same result may be achieved using the certificate during a Wi-Fi authentication process, but the user device does not necessarily need to be connected to the venue Wi-Fi network. The certificate may be used to authenticate the venue for the device that the music streaming app is present. For example, a cloud based music streaming service can verify the venue IDs by checking its venue database and ensuring that these venues are subscribers to its offered service.

In some embodiments, a venue owner can assign different priorities to zones that will be detected and communicated by the client device to the cloud streaming backend. The priority of a zone will be assigned in the certificate that is being broadcast by the radio beacon. For instance, a zone in the fitting room is or a zone at the checkout line may be at a higher priority compared to other zones. Once a client is detected to be in one of these higher-priority zones, songs from their playlist will be assigned a higher coefficient by the playlist construction algorithm. Thus, users who are at these special zones may be able to hear their favorite songs. In some embodiments, venue zone database 305 will store the priority of each zone.

In some embodiments, within the certificate that the radio beacon that is being broadcast, venue IDs hold two sections: a primary one indicating the brand (e.g., Zara) and the secondary one indicating a specific branch (e.g., Times Square store and/or a store number). Once the client hears the beacon and communicates the certificate to the cloud backend, the venue IDs will be stripped into these two sections. Once a visitor client device reports that they are at a brand venue but in different location from the location they usually visit, a crowdsourced playlist generation algorithm will assign them a higher coefficient value despite it being the client device's first time at that different venue.

In some embodiments, music may fade in when the visitor device is approaching a beacon and fade out as they are moving away from the venue beacon. In some embodiments, the algorithm may be implemented in a reverse fashion for the stepping-away scenario, e.g., meaning as the visitor's distance from the beacon is becoming larger, the volume of the music may be increased slightly to attract them back to the venue and/or to a particular zone in the venue.

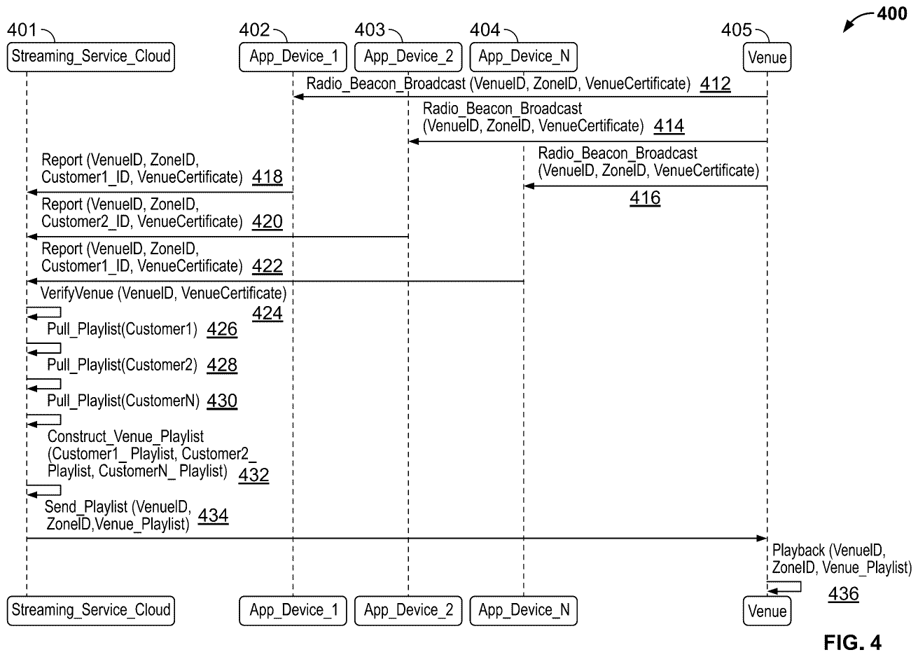

FIG. 4 shows an example sequence diagram for generating playlists from the streaming profiles of multiple customers, in accordance with some embodiments of the disclosure.

Streaming service cloud 401 may be used on devices 402, 403, and 404. Venue 405 transmits beacons to, e.g., devices 402, 403, and 404, e.g., at steps 412, 414, and 416 respectively. Each of devices 402, 403, and 404 report beacon data to streaming service cloud 401, e.g., at steps 418, 420, and 422, respectively. Then, devices 402, 403, and 404 access information such as playlists, preferences, and/or recently listened-to songs from the devices' customer profiles, e.g., at steps 426, 428, and 430, respectively. Then, e.g., at steps 418, 420, and 422, respectively, at least a portion of the data is transmitted back to venue 405 to generate a playlist, e.g., at step 432. The new and/or updated playlist may be sent at step 434 and played at step 236.

In some embodiments, the streaming service may be pulling the customer's cloud profile and their preferred playlist. This step will be repeated for all streaming service subscribers visiting the store by, e.g., sensing the store's wireless beacons. Streaming service cloud 401 may then merge such playlists to come up with a grand crowdsourced playlist for venue 405.

In some embodiments, the grand venue playlist may be generated based on who is actually present in the store currently and how long they have been in the store. Presence and duration will be computed as parameters based on hearing the beacon and communicating that received broadcast periodically (for instance at minute intervals) to the streaming service cloud 401. This method may provide higher weighting for the song preferences of customers who are at the store currently.

In some embodiments, the grand venue playlist may be generated based on whether customers are frequent visitors to the store and weight their playlist items with a higher coefficient compared to others who happen to be at the venue sporadically.

In some embodiments, the grand venue playlist may have a certain genre/theme as a default for the venue, and songs from customer playlists that are within that genre/theme are weighted more heavily during computation while finalizing the playlist. This gives the venue owner flexibility to have certain control on the vibe of the venue; however, it does not go so far as to dictate or impose the owner's (or even the cloud music service's) preferences over the visitors'/customers' preferences.

In some embodiments, the grand venue playlist may be generated based on contextual data based on the location of the venue. For instance, if the venue is in Greenwich Village or SoHo in NYC, then playlist construction will pull out more contemporary or hip or pop songs (rather than classical music or bluegrass songs) from the visitors' playlists.

In some embodiments, no playlist is constant for any venue at any time. Playlists will change based on the visits to the venue and changing characteristics of the customers as well as changing of the music library that the cloud service offers. This invention provides the structure of that dynamic playlist with the venue owner needing to make minimal (or no) interaction or effort for the construction of the playlist.

In some embodiments, a customer may be able to add the currently playing song from a playlist to their personal playlist through streaming service 401 by communicating the metadata of the currently playing song to the client device from the cloud backend and showing the thumbnail artwork of the song on a user interface.

In some embodiments, a venue owner may name or set different zones within their venue with different themes as indicated within the broadcast radio beacon. For example, within the women's section, songs that are more popular for women will be given higher preference during the crowdsource playlist composition. Similarly, for the swimsuit section, songs that have summer, vacation, and beach metadata assigned to them will be given a higher preference. Once that zone's specific beacon is no longer “heard from,” the algorithm will determine that the visitor has moved on from that section and default back to the overall venue-based playlist.

In some embodiments, audio may be played back in a spatial manner through the speakers when the user is in between zones or traversing from one zone to another. The spatial playback will be picking songs from the playlist either based on zones or it may apply to multiple songs from the crowdsourced venue playlist in terms of the songs' ranking on the playlist.

In some embodiments, streaming service 401 will also subscribe to digital wallet transaction invocations through the operating system to be notified of any occurrences when the venue radio beacon is, e.g., discoverable. Then, it will send a flag to the backend of streaming service cloud 401 that this is a “higher” value visitor of the venues, and therefore the algorithm that puts together the playlist should use a higher coefficient in terms of songs from this specific visitor. This creates a connection between a venue ID and a loyalty card that may be stored in a mobile device's digital wallet. For instance, if a user is at the GIANT grocery store and the music streaming app queries their digital wallet and finds out that the GIANT rewards card is in the digital wallet despite the user not invoking the digital wallet for a transaction, the app will still communicate back to streaming service cloud 401 that this user is a higher-value user for the venue just being there compared to another visitor that does not have a loyalty card. In turn, the crowdsourced playlist algorithm will assign a higher coefficient for the particular playlist items. In order to implement this solution, the venue digital loyalty card will have the venue ID stored digitally in the card and answer the query with that ID when the music streaming app on the device sends the query.

In some embodiments, if a very high-value type of visitor is at the venue, the venue playlist may directly default to that customer's entire playlist. For instance, if a user is an executive chairman of a company or a platinum level member of a frequent flier club, the venue playlist may include a significant amount content items (if not all) from the user's playlist(s) in the venue playlist.

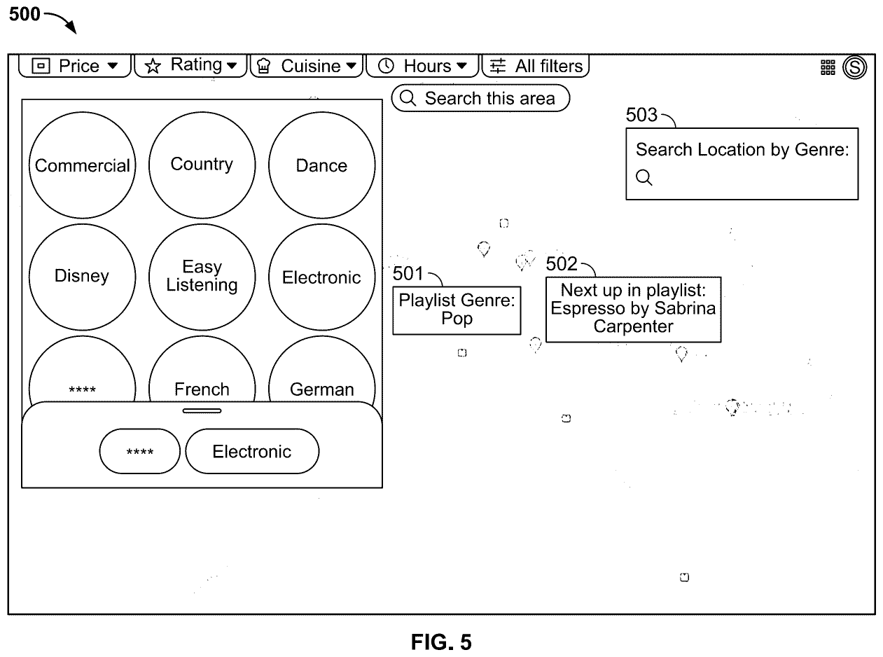

FIG. 5 depicts an example map user interface 500 that allows for searching venues by genre of playlists, in accordance with some embodiments of the disclosure.

Map user interface 500 shows a map with various venues on it, such as “Flip & Bailey's” and “Conestoga Style Pizza.” In some embodiments, a user may use map user interface 500 to see what kinds of playlists are being played at various venues. For example, UI element 501 shows that “Flip & Bailey's” is playing the genre pop. In some embodiments, a user may use map user interface 500 to see what song is up next in a playlist at a venue. For example, UI element 502 shows that “Conestoga Style Pizza” is playing the song “Espresso” by Sabrina Carpenter next in the queue. In some embodiments, a user may use map user interface 500 to search for a venue by genre using search UI element 503.

In some embodiments, users can perform genre or playlist-based searches on a map to find venues that align with their music taste. Another search that can be supported by such data would be to query spaces that are aligned with the community that a user might be seeking in a venue and associate the items in the playlist with the vibe/culture of the venue.

In some embodiments, a user, thanks to the cloud-side recorded history of venue visitation, venue playlist and on device digital wallet transaction data, can click on a transaction on the device wallet and/or invoke another past activity (such as physical exercise as detected by the device itself or smart watch IMU sensors) and re-listen to the song/audio that was playing at the time. A user will also be given information about the specific venue info. Furthermore, with an API that connects the cloud music streaming service and a mapping application, user can also query such historical occasions from a map interface as well.

In some embodiments, a music streaming service cloud backend will collect data about the venue playlists and visitors at those venues over a time period and store this historical data. The streaming service will provide access to the collected data via an API to third party applications. For instance, some embodiments may use third-party applications such as a mapping application, brand/marketing application, merchandise/sales applications, inventory databases, etc. Receiving this data, e.g., if a user is performing a search on Google Maps for a restaurant, a genre associated for the returned restaurant list may be shown by the mapping application.

In some embodiments, a venue is not a fixed location but a mobile one such as a ride sharing vehicle. Once the “mobile venue” (such as an Uber vehicle) detects the user is in the venue, meaning the ride has started in the vehicle, it may offer a customized playlist that is specific to the destination, fits into the length of the ride sharing trip, crowdsourced by past riders who started their ride from the same starting point, and/or crowdsourced by past riders that has a similar destination vicinity. Some embodiments may use a car, bus, train car, airplane, etc. for, e.g., a mobile venue.

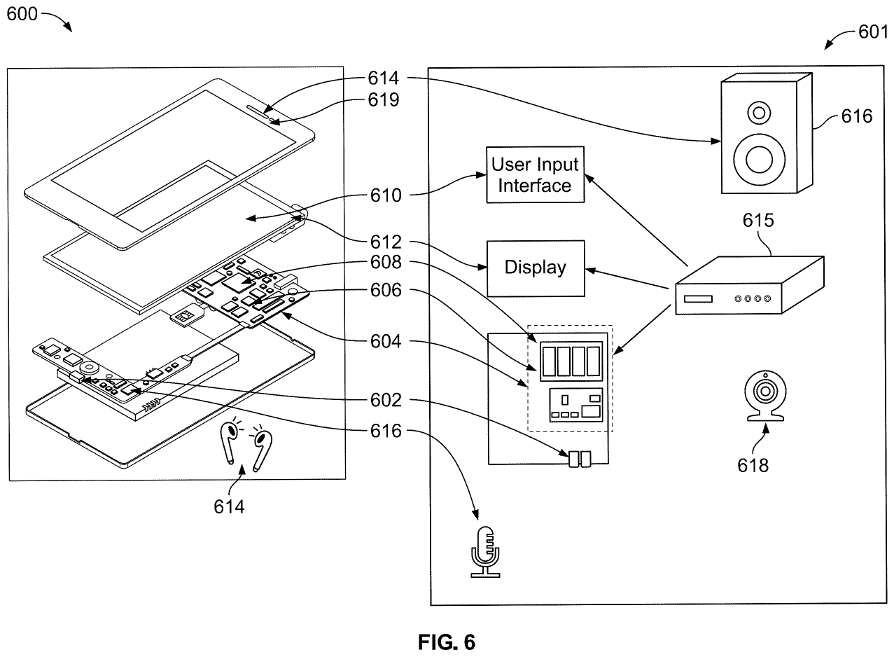

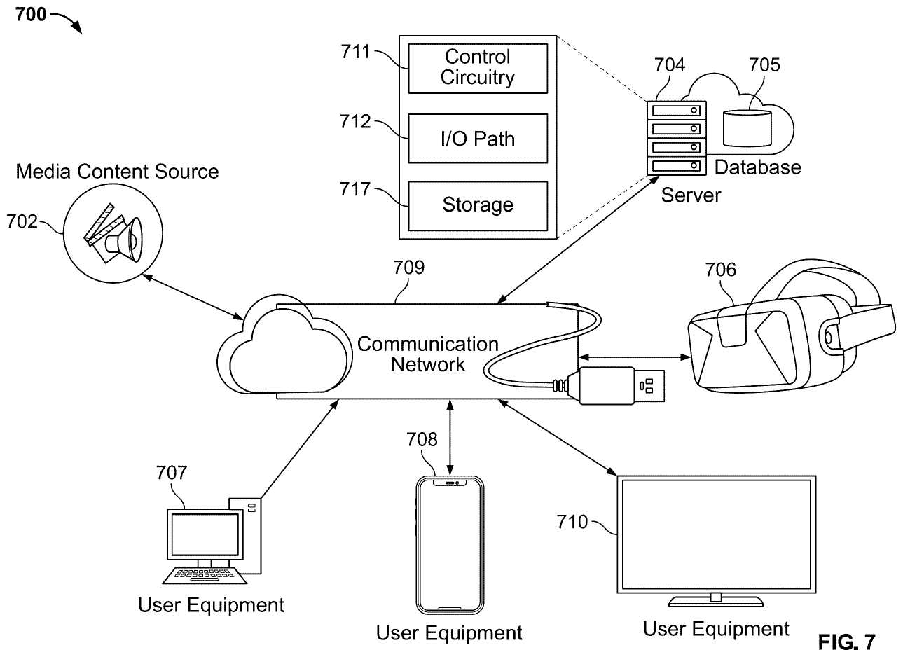

FIGS. 6-7 describe exemplary devices, systems, servers, and related hardware for streaming content in a low latency system, in accordance with some embodiments of the present disclosure.

FIG. 6 shows generalized embodiments of illustrative user equipment device 600. In some embodiments, user equipment device 600 may be a smartphone device, remote control, any other suitable device, and/or any combination thereof. In another example, user equipment system 600 may be a user television equipment system. User television equipment system 600 may include a set-top box 616. Set-top box 616 may be communicatively connected to speaker 614 and display 612. In some embodiments, display 612 may be a television display or a computer display. In some embodiments, set top box 616 may be communicatively connected to user interface input 610. In some embodiments, user interface input 610 may be a remote-control device. Set-top box 616 may include one or more circuit boards. In some embodiments, the circuit boards may include processing circuitry, control circuitry, and storage (e.g., RAM, ROM, Hard Disk, Removable Disk, etc.). In some embodiments, circuit boards may include an input/output path. More specific implementations of user equipment devices are discussed below in connection with FIG. 7. Each one of user equipment device 600 and user equipment system 600 may receive content and data via input/output (hereinafter “I/O”) path 602. I/O path 602 may provide content (e.g., broadcast programming, on-demand programming, Internet content, content available over a local area network (LAN) or wide area network (WAN), enhanced interactive content (including contextual information) and/or other content) and data to control circuitry 604, which includes processing circuitry 606 and storage 608. Control circuitry 604 may be used to send and receive commands, requests, and other suitable data using I/O path 602. I/O path 602 may connect control circuitry 604 (and specifically processing circuitry 606) to one or more communications paths (described below). I/O functions may be provided by one or more of these communications paths but are shown as a single path in FIG. 6 to avoid overcomplicating the drawing.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for an application stored in memory (e.g., storage 608), such the content consumption system. Specifically, control circuitry 604 may be instructed by the content consumption system to perform the functions discussed above and below. For example, the content consumption system may provide instructions to control circuitry 604 to generate the enhanced interactive content, including indicators and contextual information. In some implementations, any action performed by control circuitry 604 may be based on instructions received from the content consumption system. In client-server-based embodiments, control circuitry 604 may include communications circuitry suitable for communicating with a content consumption system server or other networks or servers. The instructions for carrying out the above-mentioned functionality may be stored on the content consumption system server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as enhanced interactive content data described above. Nonvolatile memory may also be used (e.g., to launch a boot-up routine and other instructions). Cloud-based storage, described in relation to FIG. 7, may be used to supplement storage 608 or instead of storage 608. Control circuitry 604 may include video-generating circuitry and tuning circuitry, such as one or more analog tuners, one or more MPEG decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for up-converting and down-converting content into the preferred output format of the user equipment 600. Circuitry 604 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive enhanced interactive content data. The circuitry described herein, including, for example, the tuning, video-generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture functions, multiple-tuner recording, etc.). If storage 608 is provided as a separate device from user equipment 600, the tuning and encoding circuitry (including multiple tuners) may be associated with storage 608.

A user may send instructions to control circuitry 604 using user input interface 604. User input interface 604 may be any suitable user interface, such as a remote control, mouse, 30 trackball, keypad, keyboard, touchscreen, touchpad, stylus input, joystick, voice recognition interface, or other user input interfaces. Display 612 may be provided as a stand-alone device or integrated with other elements of each one of user equipment device 600 and user equipment system 600. For example, display 612 may be a touchscreen or touch-sensitive display. In such circumstances, user input interface 610 may be integrated with or combined with display 612. Display 612 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thinfilm transistor display, organic light-emitting diode display, surface-conduction electronemitter display (SED), laser television, carbon nanotubes, quantum dot display, interferometric modulator display, or any other suitable equipment for displaying visual images. In some embodiments, display 612 may be HDTV-capable. In some embodiments, display 612 may be a 3D display, and the interactive application and any suitable content may be displayed in 3D. A video card or graphics card may generate the output to the display 612. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 604. The video card may be integrated with the control circuitry 604. Speakers 614 may be provided as integrated with other elements of each one of user equipment device 600 and user equipment system 600 or may be stand-alone units. The audio component of videos and other content displayed on display 612 may be played through speakers 614. In some embodiments, the audio may be distributed to a receiver (not shown), which processes and outputs the audio via speakers 614.

The content consumption system may be implemented using any suitable architecture. For example, it may be a stand-alone application wholly implemented on each one of user equipment device 600 and user equipment system 600. In such an approach, instructions of the content consumption system are stored locally (e.g., in storage 608), and data for use by the content consumption system is downloaded on a periodic basis (e.g., from an out-of-band feed, from an Internet resource, or using another suitable approach). Control circuitry 604 may retrieve instructions of the content consumption system from storage 608 and process the instructions to generate any of the displays discussed herein. Based on the processed instructions, control circuitry 604 may determine what action to perform when input is received from input interface 610. For example, movement of a cursor on a display up/down may be indicated by the processed instructions when input interface 610 indicates that an up/down button was selected.

In some embodiments, the content consumption system is a client-server-based application. Data for use by a thick or thin client implemented on each one of user equipment device 600 and user equipment system 600 is retrieved on-demand by issuing requests to a server remote to each one of user equipment device 600 and user equipment system 600. In one example of a client-server-based content consumption system, control circuitry 604 runs a web browser that interprets web pages provided by a remote server. For example, the remote server may store the instructions for the content consumption system in a storage device. The remote server may process the stored instructions using circuitry (e.g., control circuitry 604) and generate the displays discussed above and below. The client device may receive the displays generated by the remote server and may display the content of the displays locally on equipment device 600. This way, the processing of the instructions is performed remotely by the server while the resulting displays are provided locally on equipment device 600. Equipment device 600 may receive inputs from the user via input interface 610 and transmit those inputs to the remote server for processing and generating the corresponding displays. For example, equipment device 600 may transmit a communication to the remote server indicating that an up/down button was selected via input interface 610. The remote server may process instructions in accordance with that input and generate a display of the content consumption system corresponding to the input (e.g., a display that moves a cursor up/down). The generated display of content is then transmitted to equipment device 600 for presentation to the user. In some embodiments, the content consumption system is downloaded and interpreted or otherwise run by an interpreter or virtual machine (run by control circuitry 604). In some embodiments, the content consumption system may be encoded in the ETV Binary Interchange Format (EBIF), received by control circuitry 604 as part of a suitable feed, and interpreted by a user agent running on control circuitry 604. For example, the content consumption system may be an EBIF application. In some embodiments, the content consumption system may be defined by a series of JAVA-based files that are received and run by a local virtual machine or other suitable middleware executed by control circuitry 704. In some of such embodiments (e.g., those employing MPEG-2 or other digital media encoding schemes), the content consumption system may be, for example, encoded and transmitted in an MPEG-2 object carousel with the MPEG audio and video packets of a program.

Each one of user equipment device 600 and user equipment system 600 of FIG. 6 can be implemented in system 700 of FIG. 7 as user television equipment 702, user computer equipment 704, wireless user communications device 706, or any other type of user equipment suitable for accessing content, such as a non-portable gaming machine. For simplicity, these devices may be referred to herein collectively as user equipment or user equipment devices and may be substantially similar to user equipment devices described above. User equipment devices, on which the content consumption system may be implemented, may function as a standalone device or may be part of a network of devices. Various network configurations of devices may be implemented and are discussed in more detail below. A user equipment device utilizing at least some of the system features described above in connection with FIG. 6 may not be classified solely as user television equipment 702, user computer equipment 704, or a wireless user communications device 706. For example, user television equipment 702 may, like some user computer equipment 704, be Internet-enabled allowing for access to Internet content, while user computer equipment 704 may, like some television equipment 702, include a tuner allowing for access to television programming. The content consumption system may have the same layout on various different types of user equipment or may be tailored to the display capabilities of the user equipment. For example, on user computer equipment 704, the content consumption system may be provided as a website accessed by a web browser. In another example, the content consumption system may be scaled down for wireless user communications devices 706. In system 700, there is typically more than one of each type of user equipment device but only one of each is shown in FIG. 7 to avoid overcomplicating the drawing. In addition, each user may utilize more than one type of user equipment device and also more than one of each type of user equipment device.

In some embodiments, a user equipment device (e.g., user television equipment 702, user computer equipment 704, wireless user communications device 706) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user equipment devices may be coupled to communications network 714. Namely, user television equipment 702, user computer equipment 704, and wireless user communications device 706 are coupled to communications network 714 via communications paths 708, 710, and 712, respectively. Communications network 714 may be one or more networks including the Internet, a mobile phone network, mobile voice or data network (e.g., a 4G, 5G, or LTE network), cable network, public switched telephone network, or other types of communications network or combinations of communications networks. Paths 708, 710, and 712 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 712 is drawn with dotted lines to indicate that in the exemplary embodiment shown in FIG. 7 it is a wireless path and paths 708 and 710 are drawn as solid lines to indicate they are wired paths (although these paths may be wireless paths, if desired). Communications with the user equipment devices may be provided by one or more of these communications paths but are shown as a single path in FIG. 7 to avoid overcomplicating the drawing.

Although communications paths are not drawn between user equipment devices, these devices may communicate directly with each other via communication paths, such as those described above in connection with paths 708, 710, and 712, as well as other short range point-to-point communication paths, such as USB cables, IEEE 1394 cables, wireless paths (e.g., Bluetooth, infrared, IEEE 302-11x, etc.), or other short-range communication via wired or wireless paths. BLUETOOTH is a certification mark owned by Bluetooth SIG, INC. The user equipment devices may also communicate with each other directly through an indirect path via communications network 314.

System 700 includes content source 716 and enhanced media guidance data source 718 coupled to communications network 714 via communication paths 520 and 522, respectively. Paths 520 and 522 may include any of the communication paths described above in connection with paths 708, 710, and 712. Communications with the content source 716 and enhanced media guidance data source 718 may be exchanged over one or more communications paths but are shown as a single path in FIG. 7 to avoid overcomplicating the drawing. In addition, there may be more than one of each of content source 716 and enhanced media guidance data source 718, but only one of each is shown in FIG. 7 to avoid overcomplicating the drawing. (The different types of each of these sources are discussed below.) If desired, content source 716 and enhanced media guidance data source 718 may be integrated as one source device. Although communications between sources 716 and 718 with user equipment devices 702, 704, and 706 are shown as through communications network 714, in some embodiments, sources 716 and 718 may communicate directly with user equipment devices 702, 704, and 706 via communication paths (not shown) such as those described above in connection with paths 708, 710, and 712. Enhanced media guidance data source 718 may contain an enhanced metadata database.

Content source 716 may include one or more types of content distribution equipment including a cloud music platform (e.g., Spotify®, Apple Music®, YouTube®, Amazon® Music, etc.), radio station (e.g., AM/FM, Sirius XM®, internet radio), podcast or audiobook server, television distribution facility, cable system headend, satellite distribution facility, programming sources (e.g., television broadcasters, such as NBC, ABC, HBO, etc.), intermediate distribution facilities and/or servers, internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 716 may be the originator of content (e.g., a television broadcaster, a Webcast provider, etc.) or need not be the originator of content (e.g., an on-demand content provider, an Internet provider of content of broadcast programs for downloading, etc.). Content source 716 may include cable sources, satellite providers, on-demand providers, Internet providers, over-the-top content providers, or other providers of content. Content source 716 may also include a remote media server used to store different types of content (including video content selected by a user), in a location remote from any of the user equipment devices.

Enhanced media guidance data source 718 may provide enhanced metadata, including contextual information for respective audio/video content objects provided by content source 716. Enhanced metadata may be provided to the user equipment devices using any suitable approach. In some embodiments, the content consumption system may be a stand-alone application that receives enhanced metadata via a data feed (e.g., a continuous feed or trickle feed). Enhanced metadata and other data may be provided to the user equipment on a television channel sideband, using an in-band digital signal, using an out-of-band digital signal, or by any other suitable data transmission technique. Enhanced metadata and other data may be provided to user equipment on multiple analog or digital television channels.

In some embodiments, enhanced metadata from enhanced media guidance data source 718 may be provided to user equipment using a client-server approach. For example, a user equipment device may pull enhanced metadata from a server, or a server may push enhanced metadata to a user equipment device. In some embodiments, a content consumption system client residing on the user's equipment may initiate sessions with source 718 to obtain enhanced metadata when needed, such as when the local enhanced metadata is out of date or when the user equipment device receives a request from the user to receive data. Enhanced metadata may be provided to the user equipment with any suitable frequency (e.g., continuously, daily, a user-specified period of time, a system-specified period of time, in response to a request from user equipment, etc.). Enhanced media guidance data source 718 may provide user equipment devices 702, 704, and 706 the content consumption system itself or software updates for the content consumption system.

Applications may be, for example, stand-alone applications implemented on user equipment devices. For example, the content consumption system may be implemented as software or a set of executable instructions which may be stored in storage 608 and executed by control circuitry 604 of each one of user equipment device 600 and user equipment system 600. In some embodiments, applications may be client-server applications where only a client application resides on the user equipment device, and a server application resides on a remote server. For example, applications may be implemented partially as a client application on control circuitry 604 of each one of user equipment device 600 and user equipment system 600 and partially on a remote server as a server application (e.g., enhanced media guidance data source 718) running on control circuitry of the remote server. When executed by control circuitry of the remote server (such as enhanced media guidance data source 718), the content consumption system may instruct the control circuitry to generate the content consumption system displays and transmit the generated displays to the user equipment devices. The server application may instruct the control circuitry of the enhanced media guidance data source 718 to transmit data for storage on the user equipment. The client application may instruct control circuitry of the receiving user equipment to generate the content consumption system displays.

Content and/or enhanced metadata delivered to user equipment devices 702, 704, and 706 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP need not be responsible for the viewing abilities, copyrights, or redistribution of the content, and, in one suitable approach, only transfer IP packets provided by the OTT content provider. Examples of OTT content providers include YOUTUBE®, NETFLIX®, and HULU®, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide enhanced metadata described above. In addition to content and/or enhanced metadata, providers of OTT content can distribute applications (e.g., web-based applications or cloud-based applications), or the content can be displayed by applications stored on the user equipment device.

System 700 is intended to illustrate a number of approaches, or network configurations, by which user equipment devices and sources of content and enhanced metadata may communicate with each other for the purpose of accessing content and providing respective contextual information. The embodiments described herein may be applied in any one or a subset of these approaches, or in a system employing other approaches for delivering content and providing contextual information.

For example, in one suitable approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 714. These cloud resources may include one or more content sources 716 and one or more enhanced metadata sources 718. In addition, or in the alternative, the remote computing sites may include other user equipment devices, such as user television equipment 702, user computer equipment 704, and wireless user communications device 706. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 704 or wireless user communications device 706 having a content capture feature. Alternatively, the user can first transfer the content to a user equipment device, such as user computer equipment 704. The user equipment device storing the content uploads the content to the cloud using a data transmission service on communications network 714. In some embodiments, the user equipment device itself is a cloud resource, and other user equipment devices can access the content directly from the user equipment device on which the user stored the content.

Cloud resources may be accessed by a user equipment device using, for example, a web browser, an application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 6.

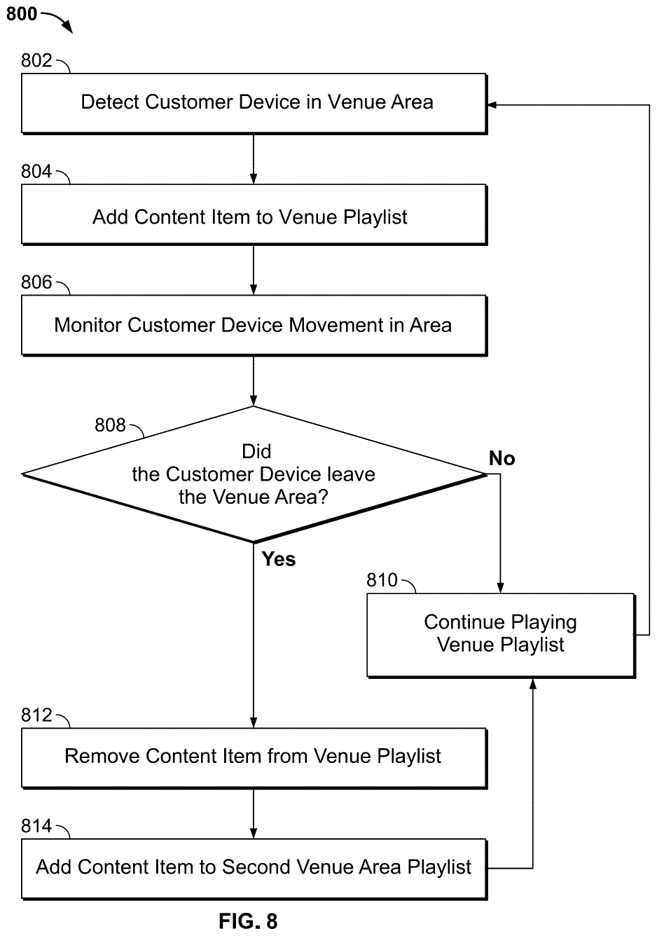

FIG. 8 is a flowchart depicting illustrative steps for generating a venue playlist, in accordance with some embodiments of the disclosure. Process 800 generally describes dynamic venue playlist generation using short-range communication protocols to detect customer devices within a first area and generate personalized playlists (with content, e.g., music, videos, podcasts, audiobooks, images, etc.) based on the user preferences and detected device movement. Some embodiments may use a venue playlist engine to perform one or more parts of process 800, e.g., as part of an application stored and executed by one or more of the processors and memory of a device and/or server such as those depicted in FIGS. 6 and 7 locally and/or at a cloud-based hardware. In some embodiments, the venue playlist engine may utilize and/or coordinate with third party platforms, e.g., streaming music services and/or subscriber preference databases. Dynamic venue playlists may be generated in various venues, such as stores, malls, restaurants, bars, lounges, and other establishments where music or other content plays a significant role in the overall experience. In some embodiments, the first area may be determined by, e.g., set boundaries, signal strength, a radius or other distance(s), multi-dimensional coordinates, etc.

At step 802, the venue playlist engine uses short-range communication to detect the presence of a first customer device in a first area. For example, if a customer has a smartphone or other mobile device that is equipped with, e.g., Bluetooth or Wi-Fi capabilities, the venue playlist engine (and connected hardware) can use this technology to establish a connection with the device and determine its location within the area.

At step 804, the venue playlist engine adds a content item associated with the detected customer device to a venue playlist for the current area. This content item (e.g., a song) is typically selected based on the customer's preferences or profile (e.g., for a streaming service), which are stored in a database or other data storage system locally and/or on a remote server. For instance, if a customer has previously streamed jazz music on their phone, the system may add a relevant jazz track to the playlist when they enter the designated area. Some embodiments may select a first content item from a plurality of content items based at least in part on the first customer profile, e.g., by correlating and/or matching one or more preference indicating a title, an artist, a group, a band, a producer, a genre, an album, a tempo, a release timeframe, last played data, a playlist, popularity level, sales data, or other desired metadata, thresholds, and/or preferences. Some embodiments may select one or more content items based at least on a match and/or correlation with one or more profile characteristics of a venue and/or area (e.g., preferred genre, artist, popularity, playlist, etc.).

At step 806, the venue playlist engine continuously monitors the location of the detected customer device, e.g., using short-range communication. For instance, the venue playlist engine may detect whether the first customer device moves from the current venue area to a new area (or leaves the venue completely). This may relay to the system information about the device's movement within the area and can update the playlist accordingly. Some embodiments may detect movement within using multiple detectors, sensors, and/or network adapters. Some embodiments may detect absence of a customer device that exceeds a threshold amount of time (e.g., before returning and being detected again during the threshold of time) such as 90 seconds. Some embodiments may detect an absence of a customer device via short-range communication and/or other detectors. For instance, when a device is not necessarily detected with Bluetooth, a GPS location may be requested from the device via the internet (e.g., 4G or 5G) to establish and/or confirm that the device has left the venue. In some embodiments, a camera (or other motion sensor) may sense the movement and/or departure of a customer and trigger a short-range communication and/or detection. In some embodiments, closing of an associated application or loss of signal may also be treated like a detection of the device leaving (e.g., after a threshold amount of time).

At step 808, the venue playlist engine detects whether the first customer device moves from the current venue area to a new area. For example, if the customer leaves an area of a department store (e.g., menswear) and enters a different section of the same department store (e.g., bedding), the system will recognize this change in location. In some embodiments, the venue playlist engine detects whether the first customer device leaves the current venue. For instance, the first customer device may not be detected in the area for a time that exceeds a threshold (e.g., three minutes).

At step 810, if the venue playlist engine detects the first customer device did not move from the current venue area, the venue playlist continues playing. For instance, a customer may still be shopping in a first area of a department store until her song comes up in the playlist and is played. In some embodiments, the content item will be played on area speakers. In some embodiments, the content item will be played on personal headphones. In some embodiments, the content item will be played on displays in the area, along with area speaker and/or personal headphones. Some embodiments may use one or more speakers and beamforming to, e.g., direct sound to small areas of a venue and/or towards a tracked moving customer. In some embodiments, an alert may be sent to the first customer device notifying the user that the content item will be played soon.

At step 812, if the venue playlist engine detects the first customer device does move out of the current venue area, the venue playlist engine removes the content item associated with the first customer device from the venue playlist for the previous area. This may prevent the content item from being played unnecessarily or out of context, e.g., without the relevant user in the area. In some embodiments, e.g., if the content item fits the playlist motif, the content item may be left to play without the customer device being detected nearby and/or may be deferred for later play.

At step 814, the venue playlist engine adds the same content item associated with the first customer device to a new venue playlist for the second area, e.g., the area where the customer device moved. For instance, this may ensure that the music is relevant and engaging for the customer as they move through different parts of the venue. Some embodiments may add a content item similar to the content item associated with the first customer device to a new venue playlist for the second area because, e.g., the related content item fits the second playlist theme better. Some embodiments may add a new content item based on the preferences associated with the first customer device to a new venue playlist for the second area because, e.g., the first content item (or associated artist/song) was recently played on the second playlist. In some embodiments, after step 814, the venue playlist engine updates the priority and position of content items in the playlist based on customer streaming profiles and preferences. If multiple customer devices are detected in the same area, the system can take into account each individual's preferences to create a customized playlist that is tailored to their tastes.

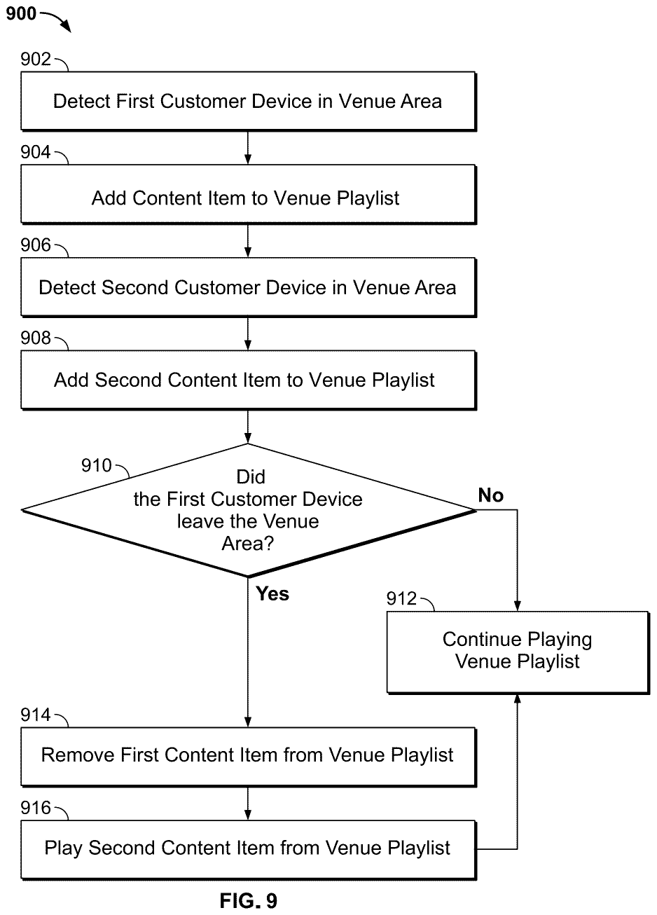

FIG. 9 is a flowchart depicting illustrative steps for generating a venue playlist, in accordance with some embodiments of the disclosure. Process 900 generally describes dynamic venue playlist generation using short-range communication protocols to detect a first customer device and a second customer device within a first area and generate personalized playlists based on user preferences and detected device movement. Some embodiments may use a venue playlist engine to perform one or more parts of process 900, e.g., as part of an application stored and executed by one or more of the processors and memory of a device and/or server such as those depicted in FIGS. 6 and 7 locally and/or at a cloud-based hardware.

At step 902, the venue playlist engine uses short-range communication to detect the presence of a first customer device in a first area. For example, if a first customer has a smartphone or other mobile device that is equipped with, e.g., Bluetooth or Wi-Fi capabilities, the venue playlist engine (and connected hardware) can use this technology to establish a connection with the device and determine its location within the area.

At step 904, the venue playlist engine adds a content item associated with the detected first customer device to a venue playlist for the current area. This content item (e.g., a song) is typically selected based on the customer's preferences or streaming profile, which are stored in a database or other data storage system locally and/or on a remote server. For instance, if a customer has previously streamed classic rock music on their phone, the system may add a relevant classic rock song to the playlist when they enter the designated area.

At step 906, the venue playlist engine uses short-range communication to detect the presence of a second customer device in a first area. For example, if a second customer has a smartphone or other mobile device that is equipped with, e.g., Bluetooth LTE capabilities, the venue playlist engine (and connected hardware) can use this technology to detect the device (e.g., via radio beacon) and determine its location within the area.

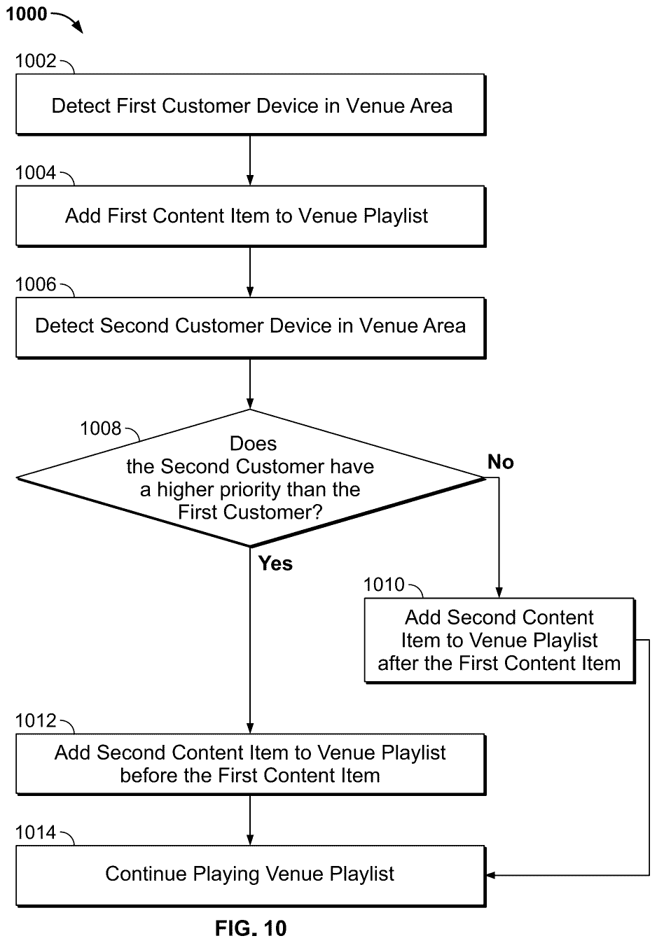

At step 908, the venue playlist engine adds a content item associated with the detected second customer device to a venue playlist for the current area. For instance, if a second customer has previously streamed holiday music on their phone (e.g., with Spotify® or Apple Music® or YouTube®), the system may add a relevant holiday song to the playlist when they enter the designated area. In some embodiments, the venue playlist may play content from a streaming platform and/or be a part of the streaming service (e.g., Spotify). In some embodiments, the playlist may be a queue where the first content item is scheduled to play before the second content item, e.g., because the first customer device was detected in the venue area prior to the second customer device being detected in the same venue area. In some embodiments, e.g., FIG. 10, the order of placement of the first content item and the second content item may be moved based on, e.g., priority level of the corresponding customer, customer profile, customer preferences, customer device qualities, type of the venue, etc. In some embodiments, the second content item may be determined based on a relationship to the first content item (e.g., same or similar artist, genre, year, duration, producer, tempo, instruments, etc.). In some embodiments, the second content item may be selected based on its difference(s) from the first content item.

At step 910, the venue playlist engine continuously monitors the location of each the detected customer devices, e.g., using short-range communication and radio beacons. For instance, the venue playlist engine may detect whether the first customer device moves from the current venue area to a new area (or leaves the venue completely). In some embodiments, the venue playlist engine may detect whether the second customer device moves from the current venue area to a new area (or leaves the venue completely). Some embodiments may require a lack of detection of the customer device for a time exceeding a threshold (e.g., 90 seconds) to ensure that, e.g., the customer device did not merely step away for a moment or briefly lose a signal. In some embodiments, the venue playlist engine detects whether the first customer device moves from the current venue area to a new area. For example, if the customer leaves an area of a department store (e.g., shoes) and enters a different section of the same department store (e.g., children), the system will recognize this change in location. Some embodiments may read, e.g., venue ID and/or zone ID information broadcasted by the beacon to, e.g., determine movement.

At step 912, if the venue playlist engine detects the first customer device did not move from the current venue area, the venue playlist continues playing. For instance, a customer may still be shopping in a first area of a department store (e.g., luggage) until his song comes up in the playlist and is played.

At step 914, if the venue playlist engine detects the first customer device has moved out of the current venue area, the venue playlist engine removes the first content item associated with the first customer device from the venue playlist for the previous area. This may prevent the content item from being played unnecessarily or out of context, e.g., without the relevant user in the area.

At step 916, the venue playlist continues playing (e.g., without the first content item). For instance, the second customer may still be shopping in a first area of a department store (e.g., sporting goods) until her song comes up in the playlist and is played.

FIG. 10 is a flowchart depicting illustrative steps for generating a venue playlist, in accordance with some embodiments of the disclosure. Process 1000 generally describes dynamic venue playlist generation using short-range communication protocols to detect a first customer device and a second customer device within a first area and generate personalized playlists based on user preferences and detected device movement. Some embodiments may use a venue playlist engine to perform one or more parts of process 1000, e.g., as part of an application stored and executed by one or more of the processors and memory of a device and/or server such as those depicted in FIGS. 6 and 7.

At step 1002, the venue playlist engine uses short-range communication to detect the presence of a first customer device in a first area. For example, if a first customer has a smartphone or other mobile device that is equipped with, e.g., Bluetooth or Wi-Fi capabilities, the venue playlist engine (and connected hardware) can use this technology to establish a connection with the device and determine its location within the area.

At step 1004, the venue playlist engine adds a content item associated with the detected first customer device to a venue playlist for the current area. This content item (e.g., a song) is typically selected based on the customer's preferences or streaming profile, which are stored in a database or other data storage system locally and/or on a remote server. For instance, if a customer has previously streamed Frank Sinatra music on their phone, the system may add a relevant Sinatra song to the playlist when they enter the designated area.

At step 1006, the venue playlist engine uses short-range communication to detect the presence of a second customer device in a first area. For example, if a second customer has a smartphone or other mobile device that is equipped with, e.g., Bluetooth LTE capabilities, the venue playlist engine (and connected hardware) can use this technology to establish a connection with the device and determine its location within the area.

At step 1008, the venue playlist engine determines whether a priority level associated with the second customer device is higher than a priority associated with the first customer device. For instance, the second customer may be a gold member and the first customer may only be a silver member. Priority may be a number (e.g., integers 1 to 3), a score (e.g., 0 to 100), a description (e.g., high, medium, low), and/or other values. In some cases, priority of a customer may be based on, e.g., recent spending at the venue, number of visits to the venue (e.g., total or during a period of time, e.g., a month or year), time spent at the venue (e.g., total or over a period of time, e.g., a week or 30 days), subscription fees, partnerships with other venues and/or service providers, signal strength, size of customer party, social network activity, content consumption, content preference alignment with the venue, etc.

If the venue playlist engine determines that the priority level associated with the second customer device is not higher than the priority associated with the first customer device, at step 1010, the venue playlist engine adds a second content item associated with the detected second customer device to a venue playlist for the current area. For instance, if the second customer—with low priority, e.g., a bronze member—has previously streamed Bruce Springsteen music on her phone (or, e.g., other streaming device), the system may add a relevant Springsteen song to the playlist, e.g., to be played after the Frank Sinatra song associated with the first customer device (e.g., a silver member).

If the venue playlist engine determines that the priority level associated with the second customer device is higher than the priority associated with the first customer device, at step 1010, the venue playlist engine adds a second content item associated with the detected second customer device to a venue playlist for the current area ahead of the first content item. For instance, if a second customer—with higher priority, e.g., a level 1 member—has previously streamed jazz music on their phone, the system may add a relevant jazz song to the playlist ahead of, e.g., the Frank Sinatra song associated with the first customer device (e.g., a level 3 member).

At step 1014, the venue playlist continues playing. Typically, songs will be played back in playlist order, e.g., as a queue. Some embodiments may have other content items added ahead based on even higher priority level, e.g., as other customer devices are detected. In some embodiments, a customer associated with a higher priority level (e.g., an “A” rating) may have multiple content items (e.g., three songs) added to the playlist and one or more of the multiple content items may be played before the content items associated with a lower priority level customer device (e.g., a “B” level). For instance, multiple jazz songs associated with a second customer with higher priority (e.g., a “red” member) may be added to the playlist ahead of, e.g., the Frank Sinatra song associated with the first customer device (e.g., a lower priority “green” member).

In some embodiments, the venue playlist engine continuously monitors the location of each the detected customer devices, e.g., using short-range communication, and may adjust priority dynamically based on, e.g., duration, location inside the area, proximity to products and/or services, signal strength, shopping cart items, wishlist items, etc. In some embodiments, the venue playlist engine may detect whether the first customer device moves from the current venue area to a new area (or leaves the venue completely) and deprioritize the content item(s) associated with the first customer device. In some embodiments, the venue playlist engine may detect whether the second customer device moves from the current venue area to a new area (or leaves the venue completely) and deprioritize the content item(s) associated with the second customer device. Some embodiments may require a lack of detection of one or more customer device(s) for a time exceeding a threshold (e.g., 180 seconds) to ensure that, e.g., the customer device did not merely step away for a moment or briefly lose a signal. In some embodiments, the venue playlist engine detects whether the first customer device moves from the current venue area to a new area and may deprioritize a content item in the playlist and/or add the content item to a playlist associated with the new area. For example, if the customer leaves an area of a department store (e.g., shoes) and enters a different section of the same department store (e.g., children), the system will recognize this change in location.

Processes and/or systems discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based on at least in part on a prior step.

1. A method comprising:
detecting, using short-range communication, a first customer device in a first area, wherein the first customer device is associated with a first customer profile;
selecting a first content item from a plurality of content items based at least in part on the first customer profile;
based at least in part on detecting the first customer device in the first area, adding the first content item to a first venue playlist to be played in the first area;
detecting, using the short-range communication, that the first customer device is in a second area; and
based at least in part on detecting that the first customer device is in a second area:
removing the selected first content item from the first venue playlist; and
adding the selected first content item to a second venue playlist to be played in the second area.

2. The method of claim 1 further comprising:
detecting, using the short-range communication, a second customer device in the first area;
based at least in part on detecting the second customer device in the first area, adding a second content item to the first venue playlist associated with the first area, wherein the second content item was selected from the plurality of content items based at least in part on a second customer profile associated with the second customer device;
based at least in part on determining that the second customer device is still in the first area and detecting that the first customer device is in a second area after leaving the first area, causing to play the second content item from the venue playlist.

3. The method of claim 2 further comprising:
determining that a first priority level of the first customer streaming profile is lower than a second priority level of the second customer streaming profile; and
based at least in part on determining that the first priority level of the first customer streaming profile is lower than the second priority level of the second customer streaming profile, adding the second content item to the first venue playlist to play before the first content item.

4. The method of claim 1 further comprising:
based at least in part on determining that the first customer device is connected to a headset, providing an offer to play the first venue playlist in the headset.

5. The method of claim 4 further comprising:
detecting a digital card associated with the first customer device; and
providing to the headset, at least one of a higher priority level or a personalized content item based at least in part on the digital card.

6. The method of claim 1, wherein the selecting the first content item from the plurality of content items based at least in part on the first customer profile further comprises selecting the first content item from a first plurality of content items based at least in part on a preference indicating at least one of a title, an artist, a group, a band, a producer, a genre, an album, a tempo, a release timeframe, last played data, a playlist, popularity level, or sales data.

7. The method of claim 1, wherein the adding the first content item associated with the first customer device to the first venue playlist further comprises:
determining that a first priority level associated with the first customer streaming profile is above a threshold priority level; and
adding at least one additional content item associated with the first customer profile to the first venue playlist.

8. The method of claim 1, wherein the selecting the first content item from the first plurality of content items further comprises:
determining a genre of the first venue playlist; and
selecting the first content item from the plurality of content items based at least in part on the first customer profile and determining that the genre of the first content item matches the genre of the first venue playlist.

9. The method of claim 1, wherein the determining that the first customer device is in the second area further comprises determining that the first customer device is no longer in the first area.

10. The method of claim 1 further comprising:
determining a genre of the first venue playlist; and
providing data indicating the genre of the venue playlist at the location of the first area for display in a map.

11. A system comprising:
memory;
control circuitry configured to:
detect, using short-range communication, a first customer device in a first area, wherein the first customer device is associated with a first customer profile;
select a first content item from a plurality of content items based at least in part on the first customer profile;
based at least in part on detecting the first customer device in the first area, add the first content item to a first venue playlist, stored in the memory, to be played in the first area;
detect, using the short-range communication, that the first customer device is in a second area; and
based at least in part on detecting that the first customer device is in a second area:
remove the selected first content item from the first venue playlist; and
add the selected first content item to a second venue playlist to be played in the second area.

12. The system of claim 11, wherein the control circuitry is further configured to:
detect, using the short-range communication, a second customer device in the first area;
based at least in part on detecting the second customer device in the first area, add a second content item to the first venue playlist associated with the first area, wherein the second content item was selected from the plurality of content items based at least in part on a second customer profile associated with the second customer device;
based at least in part on determining that the second customer device is still in the first area and detecting that the first customer device is in a second area after leaving the first area, cause to play the second content item from the venue playlist.

13. The system of claim 12, wherein the control circuitry is further configured to:
determine that a first priority level of the first customer streaming profile is lower than a second priority level of the second customer streaming profile; and
based at least in part on determining that the first priority level of the first customer streaming profile is lower than the second priority level of the second customer streaming profile, add the second content item to the first venue playlist to play before the first content item.

14. The system of claim 11, wherein the control circuitry is further configured to:
based at least in part on determining that the first customer device is connected to a headset, provide an offer to play the first venue playlist in the headset.

15. The system of claim 14, wherein the control circuitry is further configured to:
detect a digital card associated with the first customer device; and
provide to the headset, at least one of a higher priority level or a personalized content item based at least in part on the digital card.

16. The system of claim 11, wherein the control circuitry is further configured to select the first content item from the plurality of content items based at least in part on the first customer profile by selecting the first content item from a first plurality of content items based at least in part on a preference indicating at least one of a title, an artist, a group, a band, a producer, a genre, an album, a tempo, a release timeframe, last played data, a playlist, popularity level, or sales data.

17. The system of claim 11, wherein the control circuitry is further configured to add the first content item associated with the first customer device to the first venue playlist by:
determining that a first priority level associated with the first customer streaming profile is above a threshold priority level; and
adding at least one additional content item associated with the first customer profile to the first venue playlist.

18. The system of claim 11, wherein the control circuitry is further configured to select the first content item from the first plurality of content items by:
determining a genre of the first venue playlist; and
selecting the first content item from the plurality of content items based at least in part on the first customer profile and determining that the genre of the first content item matches the genre of the first venue playlist.

19. The system of claim 11, wherein the control circuitry is further configured to determine that the first customer device is in the second area further based at least in part on determining that the first customer device is no longer in the first area.

20. The system of claim 11, wherein the control circuitry is further configured to:
determine a genre of the first venue playlist; and
provide data indicating the genre of the venue playlist at the location of the first area for display in a map.

21-50. (canceled)
